(19) United States
(12) Patent Application Publication
(10) Pub. No.: US 2011/0029582 A1
(43) Pub. Date: Feb. 3, 2011

(54) METHOD AND DEVICE FOR STORING DATA BELONGING TO AN ALARM OR EVENT MESSAGE CONTAINING MULTIPLE ATTRIBUTES

(75) Inventors: Werner SCHMIDT, Heddesheim (DE); Martin Hollender, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/880,656

(22) Filed: Sep. 13, 2010

Related U.S. Application Data
(63) Continuation of application No. PCT/EP2009/001751, filed on Mar. 12, 2009.

(30) Foreign Application Priority Data
Mar. 14, 2008 (DE) 10 2008 014 151.8

(51) Int. Cl. G06F 17/30

(52) U.S. Cl. 707/812; 707/E17.044

(57) ABSTRACT

The disclosure relates to a method and to a corresponding device for storing data belonging to an alarm or event message containing multiple attributes. A fixed table directly stores a first part of the attributes belonging to an alarm or event message in a standardized manner. Additionally, both the first part and a remaining second part of the attributes are stored as an availability dataset.

### RELATED APPLICATIONS

This application claims priority as a continuation application under 35 U.S.C. §120 to PCT/EP2009/001751, which was filed as an International Application on Mar. 12, 2009 designating the U.S., and which claims priority to German Application 10 2008 014 151.8 filed in Germany on Mar. 14, 2008. The entire contents of these applications are hereby incorporated by reference in their entireties.

### FIELD

The disclosure relates to a method and a device for storing data belonging to an alarm or event notification containing a plurality of attributes.

### BACKGROUND INFORMATION

Panels, other displays, and printouts can provide notification of, alarms in industrial plants For example, a tabular structure can be used. Additionally, alarm and event notification systems compliant with the OPC AE (Alarms & Events) Specification can enable notification of manufacturer-specific attributes. A large number of different alarm and event notification devices or alarm or event sources can be integrated in open-loop and closed-loop control systems or management systems in industrial plants . The alarm and event notification devices or alarm or event sources can have different manufacturer-specific attributes. For example, there can be several hundred manufacturer-specific detector attributes in large management systems. Since new sources for alarm and event notifications are continually being integrated in open-loop and closed-loop control systems, the number of attributes is likely to increase dynamically in the future.

Process Information Management Systems (PIMS) can have the task of archiving alarm and event data, both to log an event that occurred in the industrial plant and to serve as a database for various analyses. An alarm and event data archive can enable fast access to relevant information—for example for display purposes—as well as store complete information so that the information is available for analyses, which may also be carried out at a later date.

It can become increasingly more difficult to store the dynamically increasing number of notifications in a database. Two ways that can solve the problem of providing and storing the volume of data are presented below.

According to a first known solution variant, only a relevant subset of the attributes is normalized and then stored in a fixed table. However, this process can result in part of the information being lost thereby. In sectors of industry, for example in the pharmaceutical industry, such information loss can be considered unacceptable. Moreover, it is not always known in advance what information is not relevant and what information is relevant, and therefore should be stored, and it is often also unknown in advance what subsequent analyses may be desired.

With a second known solution variant, a separate table is used for each event category. In this variant, all alarm and event attributes can be stored. However, to store all the alarm and event attributes, it may be desired that the tables be synchronized with the event sources. The synchronization can be a complex process. It may be desirable to create a large number of tables. Access to events stored in this way can involve a complex combination of information from a plurality of tables, which can make the process very slow.

### SUMMARY

A method is disclosed for storing data of an alarm or event notification containing a plurality of attributes, comprising: directly storing a first part of an attribute belonging to a normalized alarm or event notification in a fixed table of a memory device; and storing the first part and a remaining second part of the attribute as a fallback record in the memory device.

A device is disclosed, comprising: a memory; and a processor configured to perform functions of: directly storing, in a fixed table of the memory, a first part of an attribute belonging to a normalized alarm or event notification; and storing, in the memory, the first part and a remaining second part of the attribute as a fallback record.

### BRIEF DESCRIPTION OF THE DRAWING

Other objects and advantages of the present disclosure will become apparent to those skilled in the art upon reading the following detailed description in conjunction with the accompanying drawing, wherein:

FIG. 1 shows an exemplary implementation of the disclosure in schematic form.

### DETAILED DESCRIPTION

Exemplary embodiments of the disclosure are directed to a method and a device which allow all alarm and event data to be stored, as well as fast access to the data.

For example, storage of all alarm and event data, as well as fast access to the data, can be achieved by an exemplary method for storing data belonging in each case to an alarm or event notification containing a plurality of attributes.

In an exemplary method according to the disclosure and in a corresponding exemplary device for storing data of an alarm or event notification containing a plurality of attributes, a first part of the attributes belonging to an alarm or event notification can be stored normalized in a table, e.g. a fixed table.

Attributes can include, for example, name of the acknowledging user, name of the node at which an event was generated, changed value before/after, diagnostics code or time stamp.

The term fixed table refers to a table whose columns must be previously defined, but which—according to an advantageous development—can also be designed as a dynamic table to which further columns can subsequently be added.

In addition to the aforesaid normalized storing of the first part of the attributes, both the first part as well as a remaining second part of the attributes can be stored as a flat fallback record. This may be advantageously done in the XML language or in the form of BLOBs (binary large objects), for example as a database column or as a separate file.

Flat fallback record refers to a storage location as well as to all the attributes stored there in a (relatively) unstructured form. Although such a fallback record, stored in XML for example, can be poorly suited to fast querying, it does constitute a complete data record that can be used for subsequent analyses.

The normalized first part of the attributes stored in the table can be used for display purposes. The first, directly stored part of the attributes can enable very fast access. Attributes that should be available quickly can include, for example, time stamp, tag name, event category or activation time stamp. The complete information stored as a fallback record can be made available again for subsequent analyses by means of, for example, XML-processing facilities of modern databases or by means (e.g., processor and/or database) for implementing of batch procedures.

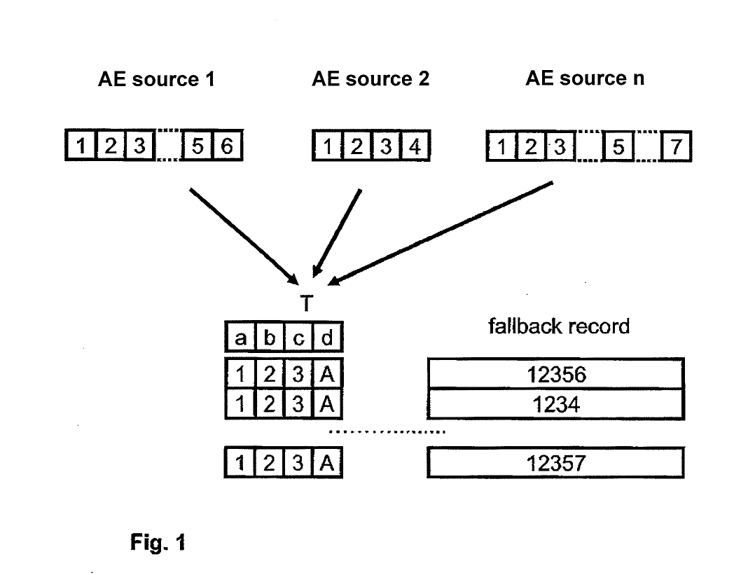

The top part of FIG. 1 shows in schematic form and by way of example several alarm and event sources AE source 1, AE source 2 to AE source n (e.g., means for notification, such as alarm devices and/or processor devices) having a plurality of attributes 1 to 7. It is assumed in the example that attributes 1 to 3 are each relevant attributes that should be available for fast access, e.g. time stamp, tag name, event category or activation time stamp. Alarm or event notifications of AE sources 1 to n are transferred into a table T (e.g., of a memory device). The table T has several columns, in the example columns a to c for the direct storage of normalized attributes, as well as an additional column d or further columns, if desired. One or more rows can store the information belonging to one or more respective alarm or event notification. The representation of the information stored in the first row of table T relates, for example, to attributes of a notification of the first AE source 1. The relevant attributes 1 to 3 are stored here directly in the three columns a to c, and in addition all attributes, here the attributes 1, 2, 3, 5 and 6, are stored in column d as a fallback record A. The fallback record, that is to say all the attributes 1, 2, 3, 5 and 6, can also be stored at another location instead (e.g., in the same, or in a different, memory device).

One rule for a normalized or converted attribute could be, for example: if Attribute1=“+” and Attribute3=“active”, then store in column d=“on”.

A fallback record could be helpful in the following exemplary scenario:
When a setpoint value of a control loop is changed, an event is generated for which the new setpoint value is stored in the attribute “NewValue”. The attribute “NewValue” is initially considered to be unimportant and is stored only in the fallback record, for example in the form:
<attributes>. . . <NewValue>xy</NewValue>. . . </attributes>.

After several years' production, the suspicion arises that certain setpoint values may result in quality problems. The quality problems can be detected by means (e.g., processor) for detecting a further event. If the attribute “NewValue” had not been stored in the fallback record, then it would be recorded only from the time at which it was recognized as important. Valuable time for data acquisition would have been lost. However, since “NewValue” is stored in the fallback record, it is possible to calculate the correlation between setpoint values and quality problems for the past production period, either:

a) by exploiting the XML capabilities of modern databases and accessing the XML element <NewValue>relatively slowly,
or

b) by creating an additional “NewValue” column and populating it retrospectively with values from the fallback record using a batch program. It would then be possible to perform the analysis very fast.

The normalization provided can align both different attribute names having the same meaning and different attribute values having the same meaning. An alignment of different attribute names can involve, for example, storing both the attribute “user_name” and the attribute “user” in the same “user” column. An example of an alignment of different attribute values having the same meaning would be: event source 1 writes “on” and “off” in the “Change” attribute, and event source 2 writes “+” and “−”. Normalization can then ensure uniformity and write “+” and “−” in both cases.

In another exemplary scenario, the fixed table T can be empty, and the alarm and event attributes can be stored solely as XML in the fallback record. The XML capability of modern databases can guarantee a sufficiently fast processing speed for many applications.

According to an exemplary advantageous development, it is possible to begin with a dynamic table T, for example, with the attributes 1, 2 and 3. When an alarm or event notification has an attribute X which is not yet present in the table T, then the table T could be automatically extended to include the attribute X and the value stored in it. The associated algorithm would then be:

check whether a column X already exists,

if yes ->store the value in column X,

if no ->create an additional column X. Store the value in column X.

If fast querying subsequently becomes desirable for accessing values in column X, a database key to this column can be created.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for storing data of an alarm or event notification containing a plurality of attributes, comprising:
directly storing a first part of an attribute belonging to a normalized alarm or event notification in a fixed table of a memory device; and
storing the first part and a remaining second part of the attribute as a fallback record in the memory device.

2. The method according to claim 1, wherein the alarm or event notification originates from a notification means in an industrial plant.

3. The method according to claim 1, wherein the attribute is stored as the fallback record in an XML form or as a BLOB.

4. The method according to claim 1, wherein the fallback record is stored in a separate file or as a database column.

5. The method according to claim 1, wherein the memory device is configured as a dynamic table which is automatically extended to store additional attributes.

6. A device, comprising:
a memory; and
a processor configured to perform functions of:
directly storing, in a fixed table of the memory, a first part of an attribute belonging to a normalized alarm or event notification; and
storing, in the memory, the first part and a remaining second part of the attribute as a fallback record.

7. A device according to claim 6, wherein the memory is configured with a dynamic table set up to automatically create additional columns for storing further attributes during operation.
